(19) United States
(12) Patent Application Publication
(10) Pub. No.: US 2011/0134315 A1
(43) Pub. Date: Jun. 9, 2011

(54) Bi-Directional, Local and Global Motion Estimation Based Frame Rate Conversion

(76) Inventors: Avi Levy, Kiryat Tivon (IL); Artiom Myaskouvskey, Haifa (IL); Barak Hurwitz, Alonim (IL)

(21) Appl. No.: 12/633,088

(22) Filed: Dec. 8, 2009

(51) Int. Cl. H04N 7/01; H04N 5/14

(52) U.S. Cl. 348/441; 348/699; 348/E07.003

(57) ABSTRACT

In accordance with some embodiments, frame rate conversion may use both forward and backward local and global motion estimation. In some embodiments, spatial and neighboring predictors may be developed for a block. A small range block matching may be done for each predictor. A final or best motion vector for a block may be selected from a plurality of candidates based on votes from neighboring blocks. A global motion vector may be computed from plurality of selected motion vectors. A motion compensated interpolation may be computed based on two consecutive frames and both forward and backward local and global motion estimations.

### BACKGROUND

This relates generally to processing video information.

Video may be supplied with a given frame rate. The video is made up of a sequence of still frames. The frame rate is the number of frames per second.

Some displays use frame rates different than the frame rate of the input video. Thus, frame rate conversion converts the frame rate up or down so that the input frame rate matches the display's frame rate.

### BRIEF DESCRIPTION OF THE DRAWINGS

FIG. 1 is a frame rate conversion apparatus in accordance with one embodiment of the present invention;

FIG. 2 is a more detailed depiction of a motion estimation unit according to one embodiment;

FIG. 3 is a more detailed depiction of the motion compensation device according to one embodiment;

FIG. 4 is a depiction of temporal and pyramid predictors in accordance with one embodiment of the present invention;

FIG. 5 is a depiction of a spatial predictor in accordance with one embodiment of the present invention;

FIG. 6 is a flow chart for one embodiment; and

FIG. 7 is a system depiction for one embodiment.

### DETAILED DESCRIPTION

Frame rate conversion is used to change the frame rate of a video sequence. A typical frame rate conversion algorithm application is to convert film content from 24 frames per second to 60 frames per second for the National Television Systems Committee (NTSC) system or from 25 frames per second to 50 frames per second for the phase alternating line (PAL) system. High definition television supports 120 or 240 frames per second display, which also needs frame up conversion. In accordance with some embodiments, the frame rate conversion algorithm may compensate for the motion depicted in the video sequence.

In one embodiment, bi-directional, hierarchical local and global motion estimation and motion compensation is used. “Bi-directional” means that the motion is estimated between two anchor frames in the forward and backward directions. “Hierarchical motion estimation” refers to the fact that motion estimation is refined with each increasing resolution of the supplied video information. The bi-directional hierarchical local and global motion estimation is followed by a final motion compensation stage that integrates the two anchor frames and all motion estimation elements into one interpolation stage.

In accordance with one embodiment, an input series of two video frames may be received. The frames may include a series of pixels specified by x, y, and time t coordinates. Motion vectors may be determined from a first to a second frame and from the second to the first frame or, in other words, in the forward and backward directions. The algorithm creates an interpolated frame between the two frames using the derived local and global motion, the time stamp provided, and the consecutive frame data. The time stamp corresponds to the frame rate and, particularly, to the frame rate desired for the output frame.

Thus, a previous frame P may have pixels specified by x, y, and t variables and a next frame N may have pixels with x, y, and t+1 variables. The output frame C has pixels with x, y, t′ variables. Interpolated output frame C may have a time t+q, where q is less than 1 and greater than 0. Pixel positions may be indicated by p in an x and y coordinates. A motion vector MV_{AB} (x,y) is the motion vector, at coordinates x and y in screen space, from a frame A to a frame B. A global motion vector GM_{AB} is the dominant motion vector from frame A to frame B.

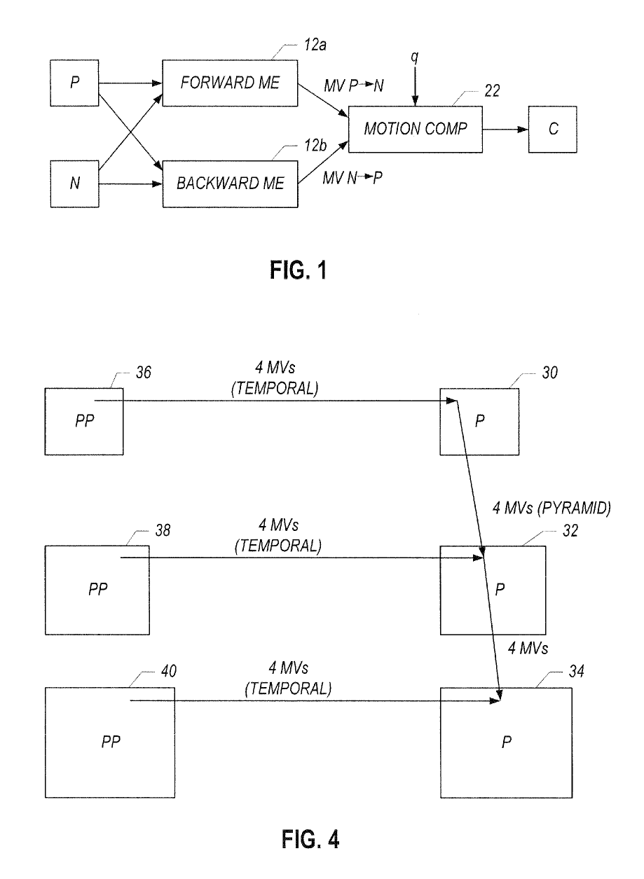

Thus, referring to FIG. 1, the previous frame P and the next frame N are provided to a forward motion estimation unit 12a and a backward motion estimation unit 12b. The output of each motion estimation unit 12 is a motion vector field and a global motion vector, either from the previous frame P to the next frame N, in the case of forward motion estimation unit 12 or from the next frame to the previous frame, in the case of the backward motion estimation unit 12b, as depicted in FIG. 1. The results of the forward and backward motion estimation are provided to a motion compensation device 22 which receives the motion vectors and the time q for the interpolated output frame C.

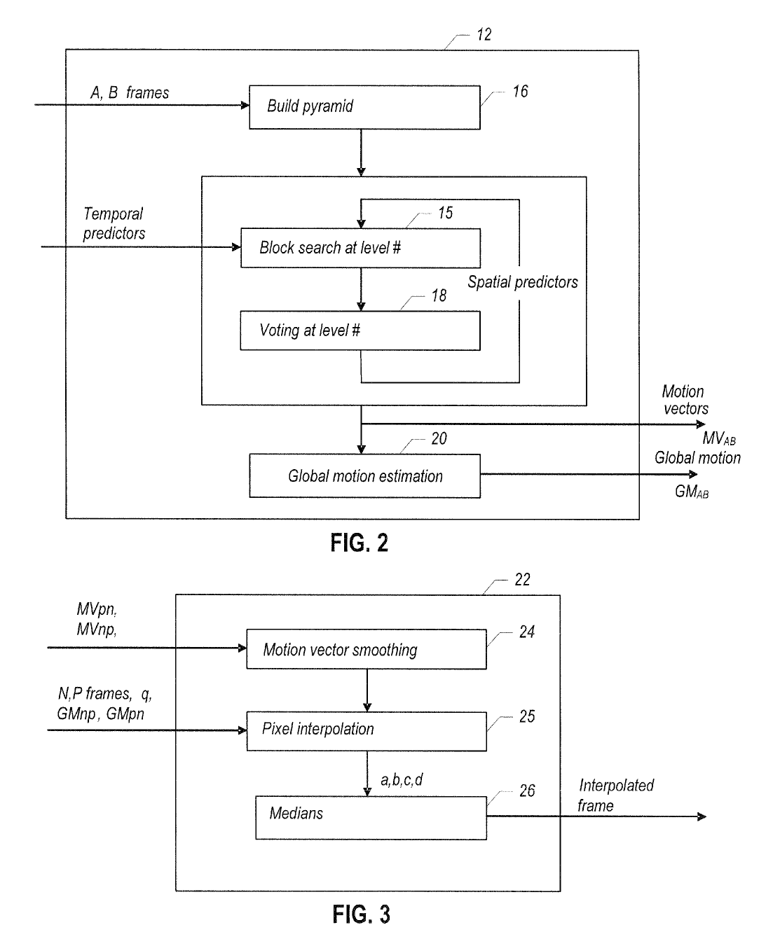

Referring to FIG. 2, the motion estimation unit 12 may implement the forward motion estimation unit 12a or the backward motion estimation unit 12b of FIG. 1. It may be implemented in software or hardware. In a hardware embodiment, a hardware accelerator may be used in some embodiments.

The input frames are indicated as A and B, including only the Y component of a Y,U,V color system, in one embodiment. Other color schemes may also be used. The input to the motion estimation unit may also include temporal predictors for each block at each of a plurality of pyramid levels of a hierarchical system. Temporal predictors are the expected locations of a source block in a reference frame according to the previous motion estimation compute. The outputs are the motion vectors, as indicated, for each block at each pyramid level and the global motion or dominant motion vector in the frame.

The sub-blocks include a pyramid block 16 for building the pyramid structure from the input frames and a global motion estimation unit 20 that computes the global or dominant motion vector from A to B. A block search unit 15 and a voting unit 18 are explained in more detailed hereinafter.

The global motion estimation unit 20 computes the dominant motion from frame A to frame B using the motion vectors from A to B of the lowest level of the pyramid referring to the original frame resolution. The average of all the motion vectors is calculated and then all motion vectors that differ significantly from that average are removed. The average of the remaining set of motion vectors is computed again and the motion vectors that differ from the new average are removed also. This process continues until it converges, meaning that the average motion vector does not change from the current iteration to the next one. The final average motion vector is the global or dominant motion vector.

The motion compensation device 22 is shown in more detail in FIG. 3. It includes a motion vector smoothing 24, pixel interpolation 25, and a median calculator 26. The motion vector smoothing 24 computes forward and backward motion vectors for each pixel of the interpolated frame on the basis of the relevant block motion vectors. The motion vector of a given pixel is a weighted average of the motion vector of the block to which it belongs and the motion vectors of its immediate neighbor blocks. The weights are computed for each pixel based on its location in the block.

The pixel interpolation unit 25 computes four interpolation versions for each color component (Y, U, and V, for example) of each pixel of the interpolated frame. The interpolation versions may be pixel a from frame N in the location indicated by the corresponding motion vector from P to N and the time stamp q, pixel b from frame P in the location indicated by the corresponding motion vector from N to P and the time stamp q, pixel d from frame N, in the location indicated by the global motion vector from P to N and the time stamp q, pixel e from frame P in the location indicated by the global motion vector from N to P and the time stamp q. The method of interpolation, in one embodiment, may be nearest neighbor interpolation or bi-linear interpolation, as well as any other interpolation method.

The median calculation 26 calculates the median of a, b, c, d and e pixels for each component, such as Y, U, V of each pixel, where c is the average of a and b pixels. The motion compensation block uses the P and N frames, including all Y, U, and V color components in a YUV system. It uses the forward motion vectors from P to N for the blocks of the lowest pyramid level only and the backward motion vectors from N to P for the blocks of the lowest pyramid level only. The forward global motion vector from P to N, and the backward global motion vector from N to P are used, as well as q, which is the time stamp of the interpolated frame and is a value between 0 and 1. The output is an interpolated frame.

The pyramid block 16 (FIG. 2) builds a pyramid structure for an image where the first or base image of the pyramid is the original image, the second or lower resolution image is a quarter the size of the base unit or original image, and the third image is a still lower resolution image of the second image, a quarter of its size.

The motion estimation procedure in the block 12 may be the same in both the forward and backward directions. The motion estimation uses the pyramid block 16, having a given number of levels. In one embodiment, three levels are utilized, but any number of levels may be provided. In order to achieve a smooth motion field, motion vector predictors from the previous level of a pyramid and from the previous motion estimation are used. The motion estimation output may include one motion vector for each 8×8 block in one embodiment.

Referring to FIG. 4, a three level pyramid is depicted with the original image 30, the second level image 32, and the third level image 34. The blocks 30, 32, and 34, all denoted P for pyramid, indicate the three levels of the pyramid representation of the N frame. The three blocks 36, 38, and 40 are labeled PP for previous pyramids, stamped for the pyramid representation of the previous frame. Again, a predictor is the expected location of a source block in a reference frame. For each 8×8 block, one predictor is computed from the motion vector field of the previous frame, denoted temporal, in FIG. 4 and four predictors are computed from the previous, smaller level of the pyramid, as indicated in FIG. 4. At the highest pyramid level, the one with the lowest resolution, there is only one spatial predictor—the zero displacement.

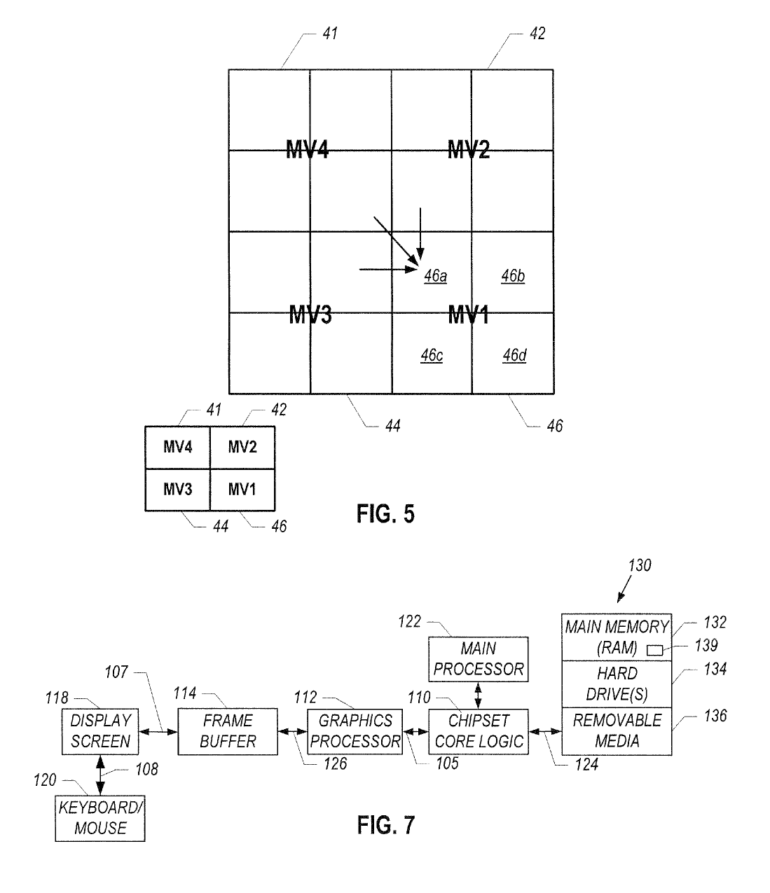

Referring to FIG. 5, each 8×8 block in a given pyramid level, indicated as 46 in FIG. 5, is related to the four blocks 46a, 46b, 46c, 46d, in lower level. Hence, each 8×8 block [46a] has one spatial predictor that originates from its direct ancestor block, indicated as the block 46 in FIG. 5, and three other predictors originating from the three neighbor blocks 41, 42, and 44.

For each predictor, a small range block matching search is performed and a similarity measure, such as the sum of absolute differences (SAD), is determined between a source block and a reference block. In this search range, the block displacement, namely, the motion vector, with the minimum sum of absolute differences is output as the candidate relating to this predictor.

In one embodiment, there are nine motion vector locations for each predictor. For each 8×8 block in the source frame and for each predictor, the search area, in one embodiment, is 10×10, so that a search range of ±1 for each direction is provided. For each direction, the search covers three positions (−1, 0, +1) and, hence, the total number of search locations is 3×3 or 9.

The selection of the final motion vector for a block is based on a process of neighbor voting. In neighbor voting, the best motion vector is chosen for each block, based on the motion vector candidates of the neighbor blocks. For each motion vector candidate of the current block, the number of resembling motion vector candidates of the eight neighbor blocks are counted. The motion vector that gets the largest number of votes, because it is a candidate in the most number of times, is chosen as the best motion vector.

The motion compensation device 22 produces the output interpolated frame C using the previous frame P and the original frame N, based on the forward motion field and the backward motion field motion vectors. The motion fields in the forward and backward directions may be smoothed by a smoothing filter 24 which, in one embodiment, may be a 9×9 filter. Each output pixel is computed as the median of five different values (a, b, c, d, and e) in one embodiment, in the median calculator 26. That is, the pixel location p in a new interpolated frame C is computed between the next N and the previous P frame. This new frame is assumed to be at a location on the time axis q between 0 and 1 between the P frame at time 0 and the N frame at time 1.

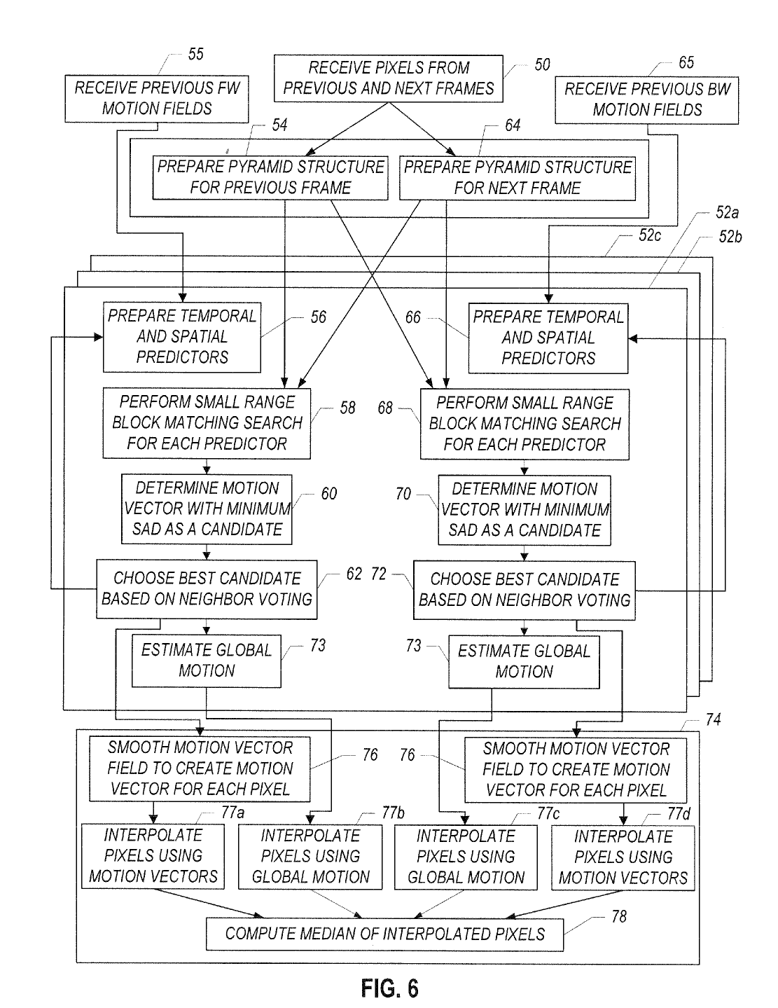

Referring to FIG. 6, in accordance with one embodiment, a sequence may be implemented in software, hardware, or firmware. In a software embodiment, the sequence may be implemented using a processor, such as a general purpose processor or a graphics processor, to execute the sequence of instructions. The sequence of instructions may be stored on a computer readable medium accessible by the executing processor. The computer readable medium may be any storage device, including a magnetic storage, a semiconductor storage, or an optical storage.

Initially, the sequence begins at block 50 by receiving the pixels for the previous and next frames. The pyramid structures for the previous and next frames are prepared in blocks 54 and 64. Thereafter, the pixels are processed in a pyramid motion estimation stage 52a, 52b, 52c. In the forward motion estimation stage, temporal and spatial predictors are developed for each 8×8 block, as indicated in block 56, using the previous forward motion fields (block 55). Next, a small range block matching is performed for each predictor, as indicated in block 58. Thereafter, the motion vector with the minimum sum of absolute differences is identified as a candidate in block 60. The best candidate from among the candidates is selected based on neighboring voting, as indicated in block 62. The motion vector results of a certain pyramid level are fed into block 73 of this level and into block 66 of the next level. Then global motion estimation is done in block 73.

The same sequence is done in blocks 65, 66, 68, 70, 72, and 73 in the backward direction.

The motion estimation results of the last pyramid level are combined for motion compensation in block 74. The motion compensation stage may include filtering to smooth the motion vector field to create a motion vector for each pixel, in blocks 76, interpolation in blocks 77a and 77d using motion vectors, and 77b and 77c using global motion, and the median calculation in block 78.

A computer system 130, shown in FIG. 7, may include a hard drive 134 and a removable medium 136, coupled by a bus 124 to a chipset core logic 110. The core logic may couple to a graphics processor 112 (via bus 105) and the main or host processor 122 in one embodiment. The graphics processor may also be coupled by a bus 126 to a frame buffer 114. The frame buffer 114 may be coupled by a bus 107 to a display screen 108, in turn, coupled to convention components by a bus 128, such as a keyboard or mouse 120. In the case of a software implementation, the pertinent computer executable code may be stored in any semiconductor, magnetic, or optical memory, including the main memory 132. Thus, in one embodiment, a code 139 may be stored in the machine readable medium, such as main memory 132 for execution by a processor, such as a processor 112 or 122. In one embodiment, the code may implement the sequence shown in FIG. 6.

In some embodiments, the bi-directional approach and the voting procedure may reduce the artifacts near object edges since these image regions are prone to motion field inaccuracy due to an aperture problem that arises in the one directional method. While the aperture problem itself is not solved by the bi-directional approach, the final interpolation is more accurate since it relies on the best results from the two independent motion fields.

The graphics processing techniques described herein may be implemented in various hardware architectures. For example, graphics functionality may be integrated within a chipset. Alternatively, a discrete graphics processor may be used. As still another embodiment, the graphics functions may be implemented by a general purpose processor, including a multicore processor.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
performing frame rate conversion using forward and backward motion estimation; and
computing forward and backward global motion estimates for frame rate conversion.

2. The method of claim 1 wherein said performing frame rate conversion using forward and backward motion estimation includes performing motion estimation using a hierarchical search.

3. The method of claim 1 including developing a temporal predictor and neighboring predictors for the selected block.

4. The method of claim 1 including performing a small range block matching for each predictor.

5. The method of claim 3 including determining a motion vector with a minimum sum of absolute differences as a candidate motion vector.

6. The method of claim 4 including selecting a final motion vector for a selected block from a plurality of candidates based on votes from neighboring blocks.

7. The method of claim 1 including performing motion compensation.

8. The method of claim 7 including calculating the median of a plurality of values including the value of a pixel taken from the next frame at a location computed from a location shifted forward by a motion vector from the previous to the next frame.

9. The method of claim 8 including calculating the median using a pixel from the previous frame at a location shifted backward by the motion vector from the next to the previous frame.

10. The method of claim 9 including determining the median of at least five values wherein one of said values is the average of the pixel taken from the next frame and the pixel taken from the previous frame.

11. The method of claim 8 including calculating the median using a pixel from the previous frame at a location shifted backward by the global motion estimate from the next to the previous frame.

12. The method of claim 8 including calculating the median using a pixel from the next frame at a location shifted forward by the global motion estimate from the previous to the next frame.

13. A computer readable medium storing instructions to enable a computer to:
forward and backward estimate local and global motion for frame rate conversion.

14. The medium of claim 13 further storing instructions to compute pixels based on interpolations using a forward motion vector and forward global motion and a backward motion vector and backward global motion.

15. The medium of claim 13 further storing instructions to develop a temporal predictor and neighboring predictors for the selected block.

16. The medium of claim 13 further storing instructions to perform a small range block matching for each predictor using a 10×10 range.

17. The medium of claim 15 further storing instructions to determine a motion vector with a minimum sum of absolute differences as a candidate motion vector.

18. The medium of claim 17 further storing instructions to select a final motion vector for a selected block from a plurality of candidates based on votes from neighboring blocks.

19. The medium of claim 13 further storing instructions to perform motion compensation.

20. The medium of claim 13 further storing instructions to perform motion compensation by calculating a median of a plurality of values including a pixel value taken from a next frame at a location computed from a location shifted forward by a motion vector from a previous to said next frame.

21. The medium of claim 20 further storing instructions to calculate the median using a pixel from a previous frame at a location shifted backward by the motion vector from the next to the previous frame.

22. The medium of claim 21 further storing instructions to determine median of at least five values wherein one of said values is the average of the pixel taken from the next frame and the pixel taken from the previous frame.

23. The medium of claim 21 further storing instructions to determine a median using a pixel from the previous frame at a location shifted backward by the global motion estimate from the next to the previous frame.

24. The medium of claim 21 further storing instructions to determine a median using a pixel from the next frame at a location shifted forward by the global motion estimate from the previous to the next frame.

25. An apparatus comprising:
a forward motion estimation unit including a voting procedure unit to select a final motion vector for a selected block from a plurality of candidates based on votes from neighboring blocks; and
a backward motion estimation unit including a voting procedure unit to select a final motion vector for a selected block from a plurality of candidates based on votes from neighboring blocks.

26. The apparatus of claim 25, said units to perform motion estimation using a hierarchical search.

27. The apparatus of claim 25 wherein said forward and backward motion estimation units to develop a temporal predictor and neighboring predictors for selected blocks.

28. The apparatus of claim 25 wherein said motion estimation units to perform a small range block matching for each predictor.

29. The apparatus of claim 27, said forward and backward motion estimation units to determine a motion vector with a minimum sum of absolute differences as a candidate motion vector.

30. The apparatus of claim 29, said motion estimation units to base the choice of the best candidate motion vector on said neighbor voting.

31. The apparatus of claim 25 wherein said motion estimation units are coupled to a motion compensation device.

32. The apparatus of claim 30 wherein said motion compensation device to calculate the median of a plurality of values including the value of a pixel taken from the next of a previous and a next frame and a location computed from a location shifted forward by a motion vector from the previous to the next frame.

33. The apparatus of claim 32 wherein said motion compensation device to calculate the median using a pixel from the previous frame shifted backward by the motion vector from the next to the previous frame.

34. The apparatus of claim 33 wherein said motion compensation device to determine the median of at least three values, wherein one of said values is the average of the pixel taken from the next frame and the pixel taken from the previous frame.

35. The apparatus of claim 34 wherein said motion compensation device to determine a median using a pixel from the previous frame at a location shifted backward by the global motion estimate from the next to the previous frame.

36. The apparatus of claim 34 wherein said motion compensation device to determine a median using a pixel from the next frame at a location shifted forward by the global motion estimate from the previous to the next frame.
